(19) United States
(12) Patent Application Publication
(10) Pub. No.: US 2014/0257975 A1
(43) Pub. Date: Sep. 11, 2014

(54) SYSTEM AND METHOD FOR MARKETING AND SELLING A REAL ESTATE PROPERTY

(71) Applicant: Marcos Rodriguez, Aspen, CO (US)

(72) Inventor: Marcos Rodriguez, Aspen, CO (US)

(73) Assignee: Marcos Rodriguez, Aspen, CO (US)

(21) Appl. No.: 13/790,302

(22) Filed: Mar. 8, 2013

(51) Int. Cl. G06Q 30/02; G06Q 50/16

(52) U.S. Cl. CPC G06Q 30/0249; G06Q 50/16
USPC 705/14.48

(57) ABSTRACT

A method and a system for marketing and selling a one or more real estate property to a buyer, is provided. The method and the system for selling and marketing the one real estate property is based upon a network in between the owner, broker, media company and the buyer. The broker checks the real estate property on multiple listing services and creates a budget for the marketing of that property. The broker then enters into an agreement with the media company i.e. the media company to be paid a percentage of the selling price of the property.

### BACKGROUND OF THE INVENTION

1. Field of the Invention

The present invention generally relates to a system and method for selling and marketing a real estate property, and more particularly relates to a system and method for selling and marketing a real estate property through minimal investment.

2. Description of Related Art

Over a million homes are bought and sold in United States of America every year. The statistics show that the majority of home buyers begin their search on the Internet. When it's a seller's market, it's about getting the listing done as soon as possible. A number of computer-based systems aid real-estate Brokers in listing real-estate parcels and prospective buyers. Such systems commonly incorporate databases searchable for particular types of parcels or other data narrowly focused upon the specific market of buying and selling the real estate itself.

Currently, uncertainty looms in the real estate sector as it tries to come to terms with the global economic crisis across the globe and its impact in United States of America as well as in the rest of the world. These are in particular trying times as both the sellers and the developers are trying to stay afloat in the market while the buyers are a lot cautious while making investments in real estate.

Even in relative good times, the Brokers are somewhat at odds with their own clients and the vendors usually the media outlets when it comes to the expense of marketing dollars (the ‘marketing problem’). The homeowner and the media vendors would like a high amount investment to be spent on the marketing of the real estate, but the Broker would like to control out-of-pocket costs.

The current system is designed such that the Broker has to spend the money out of their pocket, but the Broker has little confidence that the vendor (usually the media outlets) will perform in the appropriate marketing of the real estate by supplying quality leads and thereby yield a reasonable return on the Broker's investment.

Moreover, the marketing and advertising dollars (herein called as “MAD”) is very expensive and very speculative in today's market. The Brokers ideally wish they could do more, but since it's especially difficult to say that a particular advertisement advertising and marketing a particular property resulted in the selling of the said property, therefore there is a much forced pressure to keep the expenses down in every possible way even though it results in poor marketing of the real estate to be sold.

Therefore, there is a need for a solution that bridges the needs of the Broker and the homeowner, and puts each of the said Broker and the homeowner on the same side of the table to get the property/real estate sold in a reasonable time and for a top dollar. Furthermore, it has become increasingly important for both the owner and the Broker to have a lot more demand creation, especially with the marketing and advertising dollars (MAD) money.

### SUMMARY OF THE INVENTION

In accordance with the teachings of the present invention, a method and a system for selling and marketing of a real estate property is provided.

An object of the present invention is to provide a system capable of running a real estate marketing program for managing a network of sellers, brokers and a media company. Further, the media company being paid as a percentage of the sale of property.

Another object of the present invention is to provide a solution that bridges the need of the broker and the owner of the property, and puts each of the broker and the owner on the same side of the table to get the property sale in a reasonable time and for a top dollar.

Another object of the present invention is to provide real estate marketing and selling program wherein for the sale of the property the media company will be spending on advertising the real estate property and thus significantly increases the chance of selling a property.

Another object of the present invention is to provide real estate marketing and selling program wherein an agreement is signed between the broker and the media company for the payment to be paid after the sale of the property. Thus, the advertising will focus on elements showcasing the important and key features of the property. The continuous advertising of the real estate/property will stop only when the property is sold, and not when the Broker's budget is tapped.

Another object of the present invention is to provide real estate marketing and selling program having built-in advertising accountability, and structures a program that is Broker-friendly and Broker-driven with no risk and no upfront cost to the Broker.

These and other features, aspects, and advantages of the present invention will become better understood with reference to the following description. This summary is provided to produce a selection of concepts in a simplified form. This summary is not intended to identify key features or claimed features of the present invention, nor is it intended to be used to limit the scope of the claimed present invention.

### BRIEF DESCRIPTION OF DRAWINGS

FIG. 1 illustrates a flow chart of marketing and selling of a real estate program, in accordance with a preferred embodiment of the present invention; and

FIG. 2 illustrates a schematic overview of the components of a network environment, in accordance with another preferred embodiment of the present invention.

### DETAILED DESCRIPTION OF DRAWINGS

While this technology is illustrated and described in a preferred embodiment, a system and a method for selling and marketing a real estate property may be produced in many different configurations, forms and computer language. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

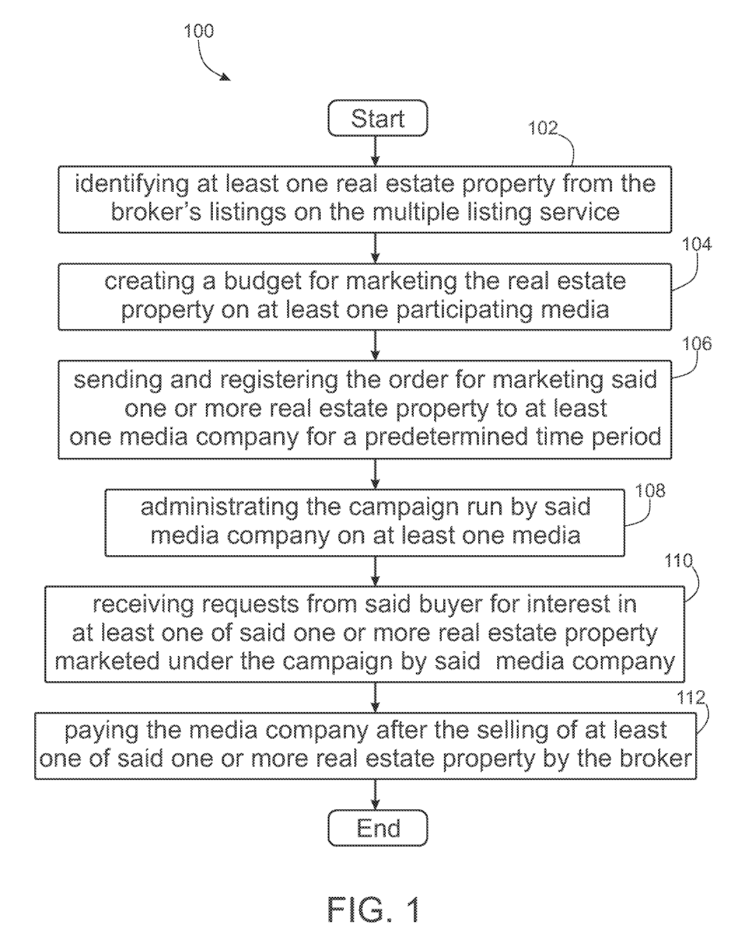

FIG. 1 illustrates a process flow of a method 100 for marketing and selling a one or more real estate property to a buyer. The method 100 initiates with a step 102 to indentify at least one real estate property from the broker's listings on the multiple listing service. In accordance with an embodiment of the present invention, the broker identifies a list of properties from the multiple listing services. The multiple listing services is a suite of services that enables real estate brokers to establish contractual offers of compensation (among brokers), facilitates cooperation with other broker participants, accumulates and disseminates information to enable appraisals, and is a facility for the orderly correlation and dissemination of listing information to better serve broker's clients, customers and the public.

The step 102 is followed by a step 104 to create a budget for marketing the real estate property on at least one participating media. The examples of one media includes but not limited to print media, visual media, audio media and digital video.

The step 104 is followed by a step 106 for sending and registering the order for marketing said one or more real estate property to at least one media company for a predetermined time period. In an embodiment of the present invention, the predetermined time period may be either in months, weeks, days or years.

The step 106 is followed by a step 108 for administrating the campaign run by said media company on at least one media. The administration is performed in order to check the regularity of the advertisements. Further, the administration also maintains the budget created marketing.

The step 108 is then followed by a step 110 for receiving requests from said buyer for interest in at least one of said one or more real estate property marketed under the campaign by said media company. In a preferred embodiment of the present invention, the interested buyers send requests to the brokers for the interest in purchase of the real estate property.

The step 110 is followed by a step 112 for paying the media company after the selling of at least one of said one or more real estate property by the broker. In a preferred embodiment of the present invention, the media company is paid only after the sale of the real estate of the property. In another preferred embodiment of the present invention, the media company is paid a percentage of the sale price of said one or more real estate property to the media company by the broker.

In a preferred embodiment of the present invention, the broker enters into an agreement with the media company. The agreement confirms that the media company will be paid only after the sale of the property.

In an embodiment of the present invention, the real estate property is either a commercial or industrial or government owned or non-government-owned or undeveloped land or newly constructed or residential.

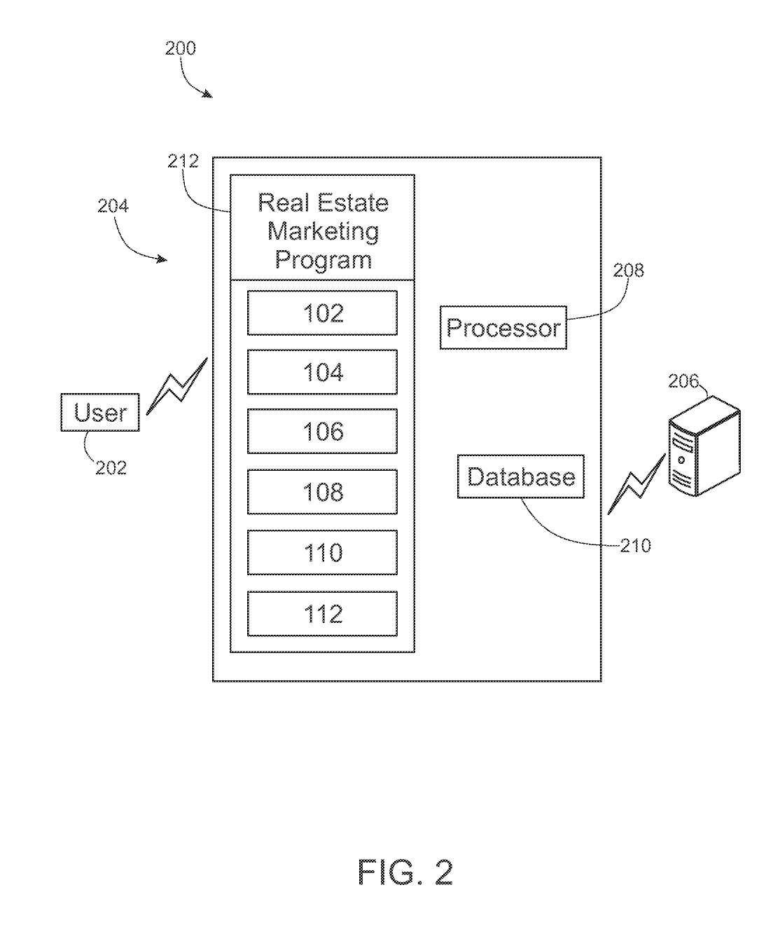

FIG. 2 illustrates a schematic overview of the components of a network environment 200. The network 200 includes a user 202, a system 204 and a server 206. The system 204 is operated by the user 202 and communicates through the server 206. In a preferred embodiment of the present invention, the system 204 is connected to a user's account through the server 206. The system 204 includes a processor 208 and a database 210. The database 210 to store a real estate marketing program 212 and the processor 208 executes the real estate marketing program 212. The real estate marketing program 212 is configured to performed the steps 102, 104, 106, 108, 110 and 112 as explained in FIG. 1 of the prevent invention.

The present invention should not be limited in its communication nomenclature. Exemplary operating systems include but not limited to SymbianOS, Windows Mobile/Windows CE, Palm OS, Linux, Blackberry OS, BREW, webOS, Android, iOS, etc. which have been developed for mobile computing applications and may handle both data computing and communication applications, e.g., voice communications. The system 100 may operate in the capacity of the server 106 or a client machine in a client-server network environment, or as a peer machine in a peer-to-peer (or distributed) network environment. Examples of database 110 includes but not limited to memory card, read-only memory (ROM), flash memory, dynamic random access memory (DRAM) (such as synchronous DRAM (SDRAM) or Rambus DRAM (RDRAM), static random access memory (SRAM) etc.

Examples of processor 108 includes but not limited to one or more special-purpose processing devices such as an application specific integrated circuit (ASIC), a field programmable gate array (FPGA), a digital signal processor (DSP), network processor etc. The processor 108 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets.

### EXAMPLE

A broker identifies a residential property for sale through a multiple listing services in Aspen, Colo. The sale price listed for the residential property is $14,900,000. The broker creates a marketing budget for this property is 0.5% of the listing price. Thus the allotted budget for marketing is $74,500. The broker then selects a media company such as an aspen radio station, an aspen newspaper and an aspen TV station to allocate this advertising budget. The broker then gets into an agreement with the media company i.e. the price for this advertising to be paid only after the sale of the property. The price here is 0.5% of the property. Thereafter, the broker finds a potential buyer of the property and on the sale of the property, the buyer of the property pays back to the owner. The owner pays to the broker and then the broker pays back to the media company.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention.

1. A method for marketing and selling a one or more real estate property to a buyer, said method comprising the steps of:
identifying at least one real estate property from the broker's listings on the multiple listing services;
creating a budget for marketing the real estate property on at least one participating media;
sending and registering the order for marketing said one or more real estate property to at least one media company for a predetermined time period;
administrating the campaign run by said media company on at least one media;
receiving requests from said buyer for interest in at least one of said one or more real estate property marketed under the campaign by said media company; and
paying the media company after the selling of at least one of said one or more real estate property by the broker.

2. The method according to claim 1 further comprising the step of creating an agreement in between said broker and said media company.

3. The method according to claim 1 wherein said real estate property is either a commercial or industrial or government owned or non-government-owned or undeveloped land or newly constructed or residential.

4. The method according to claim 1 wherein said at least one media is either print media or visual media or audio media or digital media.

5. The method according to claim 1 wherein said media company is paid as a percentage of the sale price of said one or more real estate property to the media company by the broker.

6. A system for marketing and selling a one or more real estate property to a buyer, said system connected to a server comprising:
a processor; and
a database coupled to said processor, said database to store a real estate marketing program executed from said processor, wherein said real estate marketing program coupled to said server comprising the steps of:
identifying at least one real estate property from the broker's listings on the multiple listing service;
creating a budget for marketing the real estate property on at least one participating media;
sending and registering the order for marketing said one or more real estate property to at least one media company for a predetermined time period;
administrating the campaign run by said media company on at least one media;
receiving requests from said buyer for interest in at least one of said one or more real estate property marketed under the campaign by said media company; and
paying the media company after the selling of at least one of said one or more real estate property by the broker.

7. The system according to claim 6 wherein said real estate marketing program further comprising the step of creating an agreement in between said broker and said media company.

8. The system according to claim 6 wherein said real estate property is either a commercial or industrial or government owned or non-government-owned or undeveloped land or newly constructed or residential.

9. The system according to claim 6 wherein said at least one media is either a print media or a visual media or an audio media or a digital media.

10. The system according to claim 6 wherein said media company is paid as a percentage of the sale price of said one or more real estate property to the media company by the broker.
